(19) United States
(12) Patent Application Publication
(10) Pub. No.: US 2015/0082957 A1
(43) Pub. Date: Mar. 26, 2015

(54) KNIFE SENSOR APPARATUS FOR CUTTING SHEET MATERIAL

(71) Applicant: Darryl C. Stein, Andover, CT (US)

(72) Inventor: Darryl C. Stein, Andover, CT (US)

(21) Appl. No.: 14/491,638

(22) Filed: Sep. 19, 2014

Related U.S. Application Data
(60) Provisional application No. 61/880,735, filed on Sep. 20, 2013.
(60) Provisional application No. 61/880,743, filed on Sep. 20, 2013.

(51) Int. Cl. B23Q 15/28; B26D 5/00; B23Q 17/09

(52) U.S. Cl. CPC B23Q 15/28; B23Q 17/0985; B26D 5/00
USPC 83/72

(57) ABSTRACT

A computer-controlled machine and variations thereof are disclosed for cutting shapes of material with a cutting tool, including a sensor for sensing or estimating a knife offset during cutting to provide feedback for reducing cut shape error caused by the knife being offset from its ideal position. An exemplary embodiment includes a proximity sensor, a knife, such as a reciprocating knife, and circuitry and/or computer readable instructions for separating the output signal of the proximity sensor into a tangent signal corresponding to the tangent offset and a normal signal corresponding to a normal offset. The reciprocating knife can include a temperature sensor which is positioned to measure the temperature of the reciprocating knife near the point of contact between the knife and the material being cut. The temperature sensor is preferably a non-contact temperature sensor such as an infrared thermometer which operates under the principle of measuring thermal radiation emitted from an object.

### CROSS-REFERENCE TO RELATED APPLICATIONS

This application claims the benefit of priority to U.S. Provisional Application Nos. 61/880,735 and 61/880,743, both filed Sep. 20, 2013, the disclosures and teachings of which are incorporated by reference herein.

### BACKROUND

1. Field

The present disclosure relates to a computer controlled machine for cutting shapes of material with a cutting tool, such as a reciprocating knife, including a sensor for sensing or estimating a knife offset during cutting to provide feedback for reducing cut shape error caused by the knife being offset from its ideal position. The present disclosure also relates to a reciprocating knife with a sensor apparatus for monitoring the temperature of the reciprocating knife near the point of contact between the reciprocating knife and a material being cut.

2. Description of Related Art

A well known usage of a tool having a reciprocating knife is the cutting of garment component shapes from stacked layers of fabric material. The tool is generally used as either a hand operated power tool for cutting material or as the working tool of a computer controlled machine for automatic cutting material. Some fabric materials cut by these well known machines are composed of thermoplastic fibers. It is a well known problem that heat generated by a reciprocating knife may cause the layers of the thermoplastic materials to fuse together. This is generally an undesirable result that can be avoided by choosing reciprocation speeds and knife feedrates (the relative velocity at which a cutting tool is advanced) to keep the knife temperature below the threshold that causes fusing.

Additionally, a well-known in the art and traditional usage of computer controlled machines for cutting shapes of material with a cutting tool is the automatic cutting of garment component shapes from stacked layers of fabric material. The knife offset may be decomposed into a tangent and a normal offset component. The normal offset is primarily a consequence of bending of the flexible knife in a direction generally normal to a tool path. The tangent offset is primarily a consequence of a knife's changing edge location, due to material being removed from the knife's edge with each sharpening, largely in a direction tangent to the tool path.

The prior art teaches an independent means for obtaining and utilizing the tangent and normal knife offset information. As disclosed in U.S. Pat. No. 4,133,235, entitled “Closed Loop Apparatus for Cutting Sheet Material,” the normal knife offset is obtained by a means that includes two flexible arms whose flexure is nominally proportional to the extent of knife bending. The displacement of the flexure is sensed by a linear variable differential transformer (LVDT) which provides a signal related to the extent of knife bending. The LVDT is used as a means for closed loop control in compensating for the knife bending during cutting. It is well known in the art that the tangent offset may be estimated from a record of the number of sharpening cycles a particular knife has encountered. The tool path is then adjusted to compensate for the tangent offset. The tangent offset is used for identifying when a knife has reached its end of life.

It is the objective of the present disclosure to provide a sensor apparatus producing a tangent signal related to the tangent offset and a normal signal related to the normal offset. Embodiments of the present disclosure offer many advantages over the prior art. First, embodiments of the present disclosure provides an economical technique of producing both the signals of the tangent and normal offsets. Second, the tangent offset signal is a direct measurement of the location of the knife edge versus estimation based on the number of times the knife is sharpened. It is believed that a direct measurement will provide more accurate information of the tangent offset and embodiments of the present disclosure may yield direct measurements. Finally, it is believed that embodiments of the present disclosure will provide a more accurate measure of the normal offset due a lower expected value of hysteresis than the prior art.

Further, it is an objective of the present disclosure to provide a sensor apparatus for monitoring the temperature of a reciprocating knife for the purpose of either manual control of the cutting process or for the automatic closed loop feedback control of the cutting process. This is advantageous over the prior art, as temperature information was previously unavailable for the purpose of preventing material damage by fusing. Determining effective speeds and feedrates is generally an experimental process, but the present disclosure is aimed at making the process more definitive, while aiming to eliminate the problem of the thermoplastic materials fusing together during cutting of the same.

### SUMMARY OF THE DISCLOSURE

One embodiment of the present disclosure includes a proximity sensor, a knife, such as a reciprocating knife, and means for separating (e.g., via suitable circuitry and/or software) the output signal of the proximity sensor into a tangent signal corresponding to the tangent offset and a normal signal corresponding to a normal offset. The knife has a cutting edge formed by a plurality of receding surfaces that are periodically sharpened. As a result, the knife's cutting edge surfaces can slowly recede over time as material is removed from the knife's cutting edge due to use. The proximity sensor preferably has an axis of sensitivity and produces an output signal related to the measured distance between itself and a target as measured along the axis of sensitivity. The target is preferably a receding surface on the knife. The proximity sensor is preferably located proximate the knife, and the knife's axis of sensitivity is typically oriented generally normal to the receding surface.

Generally, the axis of sensitivity is not parallel to either the direction of the tangent offset or the normal offset. Consequently, the output signal of the proximity sensor is a composition of both the tangent signal and the normal signal. The axis of sensitivity thereby forms an acute angle with the normal offset direction, preferably in the range of about 10 to 20 degrees, or any increment therebetween of about 0.5 degrees. Therefore, the proximity sensor's output signal is influenced by a changing normal offset attributed to knife bending. The output signal is also influenced by the distance to the receding surface which increases with each progressive sharpening cycle. As the receding surface migrates, the cutting edge also preferably migrates in the tangent offset direction, in an amount influenced by the magnitude of the acute angle.

The tangent signal varies slowly in time while the normal signal varies much more quickly by comparison. The tangent signal varies slowly in time because it corresponds to a migration of the knife edge resulting from the sharpening of the knife. As an example of the time scale associated with the tangent signal, a knife edge may progressively migrate 1.5 mm over the course of an eight hour work day. If 1.5 mm of migration corresponds to the life of a knife, then the period of the tangent signal is eight hours. In contrast, the normal signal corresponding to knife bending can have a time scale measurable in milliseconds. For example, the tool path corresponding to the geometry of a garment component shape is often irregular, thereby causing the knife to frequently turn while cutting. A turn trajectory may have a period of two milliseconds or less. The example values provided in this paragraph will vary widely dependent on the knife's application, and are given only to illustrate the large time scale difference of the tangent and normal signals.

The proximity sensor's output signal may pass through a low pass filter to obtain the tangent signal and a high pass filter to obtain the normal signal. The low pass filter may include or consist of a moving average filter. For example, the tangent signal may be calculated on an average of a preselected previous time period, such as the most recent 30 minutes of data samples of the proximity sensor's output signal. The high pass filter may include an algorithm and suitable complementary electronic components, calculating the difference of the proximity sensor's output signal and the tangent signal, thereby removing the low frequency components from the signal. Those skilled in the art of filter design will recognize the appropriate construction of both the low pass and high pass filters.

A tool path corresponding to a cut job is typically completed in a time scale measurable in minutes. Consequently, the variation of the tangent signal is typically negligible over the course of the cut job. This fact may be used to remove the need for closed loop control incorporating the tangent signal. Instead, the tangent offset may be determined from the tangent signal just prior to the start of a job. The tool path corresponding to the cut job can be adjusted to account for the tangent offset.

In another embodiment of the disclosure, the tangent signal is not utilized. For example, it may be the case that the migration of the receding surface caused by sharpening is negligible, or that the knife is of a hard material that is generally not re-sharpened. In the embodiment of the disclosure which excludes the tangent signal, it is preferable to orient the axis of sensitivity mostly normal to a face of the knife that is parallel to the tangent direction. In yet another embodiment of the disclosure, the normal signal is not utilized. For example, an application may produce negligible knife bending when a thin stack of material is cut. In the embodiment of the disclosure which excludes the normal signal, the proximity sensor may face the sharp edge of the knife, such that the axis of sensitivity is oriented mostly parallel to the tangent direction.

Another embodiment of the present disclosure includes a reciprocating knife, as discussed above, but also includes a temperature sensor which is positioned and configured to measure the temperature of the reciprocating knife near the point of contact between the reciprocating knife and a material being cut.

The temperature sensor is preferably a non-contact temperature sensor such as an infrared thermometer which operates under the principle of measuring thermal radiation emitted from an object. The non-contact temperature sensor may also be an infrared thermocouple. Those skilled in the art will recognize that equivalent techniques of non-contact temperature measurement also based on radiated thermal energy are envisioned by the present disclosure and fall within the scope of the present disclosure.

Alternatively, and in another embodiment, the temperature sensor may be a contact temperature sensor that is in either direct or indirect contact with the reciprocating knife. For example, a thermocouple may be in contact with a roller, which is in contact with the reciprocating knife, which provides a path for conducting thermal energy from the knife to the thermocouple by thermal conduction. It will be appreciated that a small air gap formed between the knife and the contact temperature sensor may still provide thermally conductive contact between the temperature sensor and the reciprocating knife for the purpose of the disclosure, provided sufficient thermal energy is conducted across the air gap via thermal conduction through the air.

In yet another embodiment of the disclosure, a display for displaying a calibrated temperature reading for an operator to read can be included. The calibrated temperature reading generally corresponds to the output of the temperature sensor. The contact sensor temperature can produce an analog voltage signal which is related to the temperature in a measured thermal unit such as Celsius, Fahrenheit, or Kelvin. Calibration can be achieved by applying a suitable conversion factor to the analog voltage signal to synthesize the displayed temperature reading. The process can further include using the temperature reading as a feedback parameter for manually controlling the reciprocation speed and feedrate. In yet another embodiment of the disclosure, the output of the temperature sensor can be used as feedback for automatic closed loop control of reciprocation speed and feedrate. A controller that regulates reciprocation speed and feedrate can apply an algorithm that uses a predetermined lookup table that sets the reciprocation speed and feedrate based on the feedback temperature.

It is to be understood that both the foregoing general description and the following detailed description are exemplary and are intended to provide further explanation of the embodiments disclosed herein.

The accompanying drawings, which are incorporated in and constitute part of this specification, are included to illustrate and provide a further understanding of the methods and systems of the disclosure. Together with the description, the drawings serve to explain the principles of the disclosed embodiments.

### BRIEF DESCRIPTION OF THE DRAWINGS

Accompanying the description are plural images illustrating the disclosed embodiments, which represent non-limiting, examples and in which:

FIG. 1 is an illustrative view of a first embodiment of the present disclosure, including a knife with proximity sensor apparatus;

FIG. 2 is a bottom plan view of the knife and proximity sensor apparatus of FIG. 1;

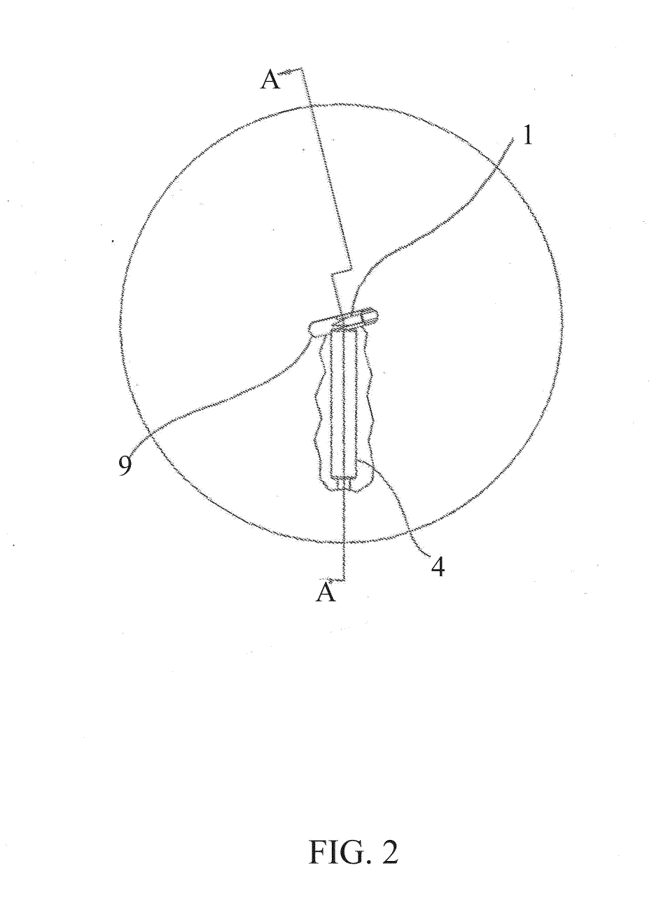

FIG. 3 is a vertical cross-sectional view of the proximity sensor apparatus of the present disclosure corresponding to the section line A-A of FIG. 2;

FIG. 4 is a side elevational view of the proximity sensor apparatus of FIG. 1;

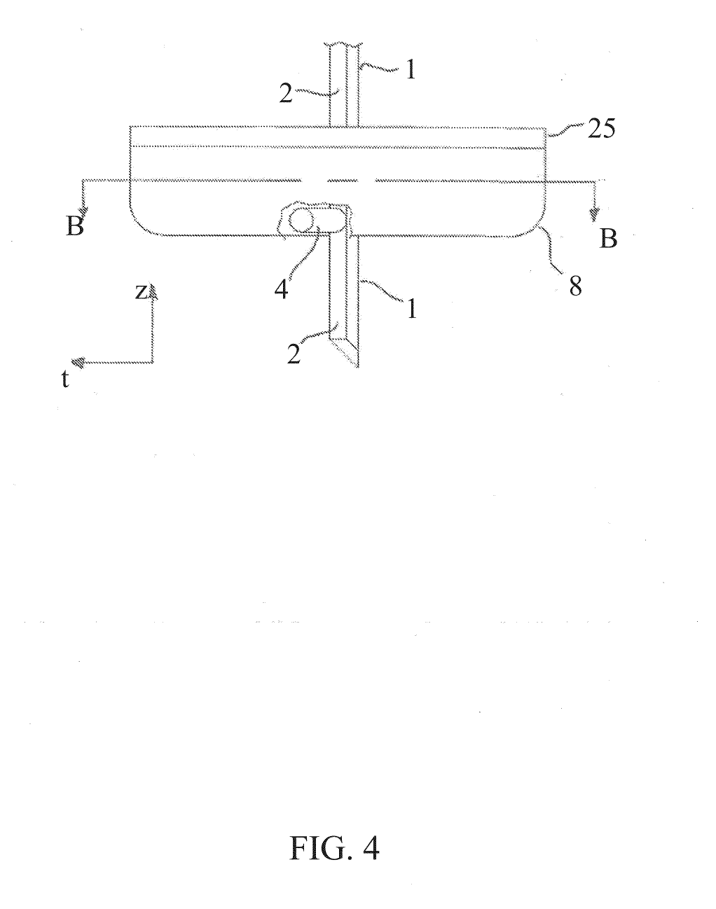

FIG. 5 is a horizontal cross-sectional view of the proximity sensor apparatus of the present disclosure corresponding to the section line B-B seen in FIG 4;

FIG. 6 is an isometric view of the knife and roller guide assembly of the present disclosure;

FIG. 7 is a schematic diagram illustrating the signal processing of the proximity sensor output of the present disclosure;

FIG. 8 is an illustrative view of an alternate embodiment of the knife of the present disclosure, having a non-contact temperature sensor apparatus; and

FIG. 9 is a side elevational view of the non-contact temperature sensor apparatus seen in FIG. 8.

### DETAILED DESCRIPTION

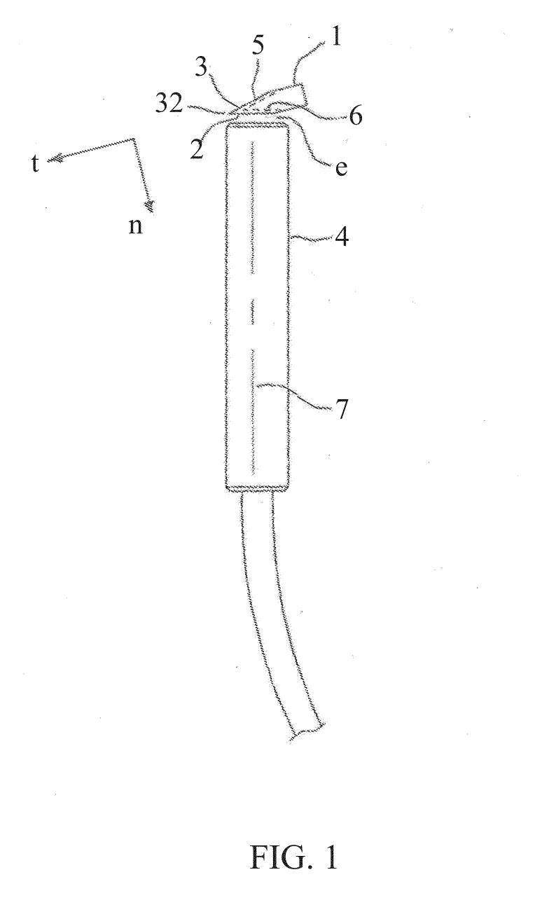

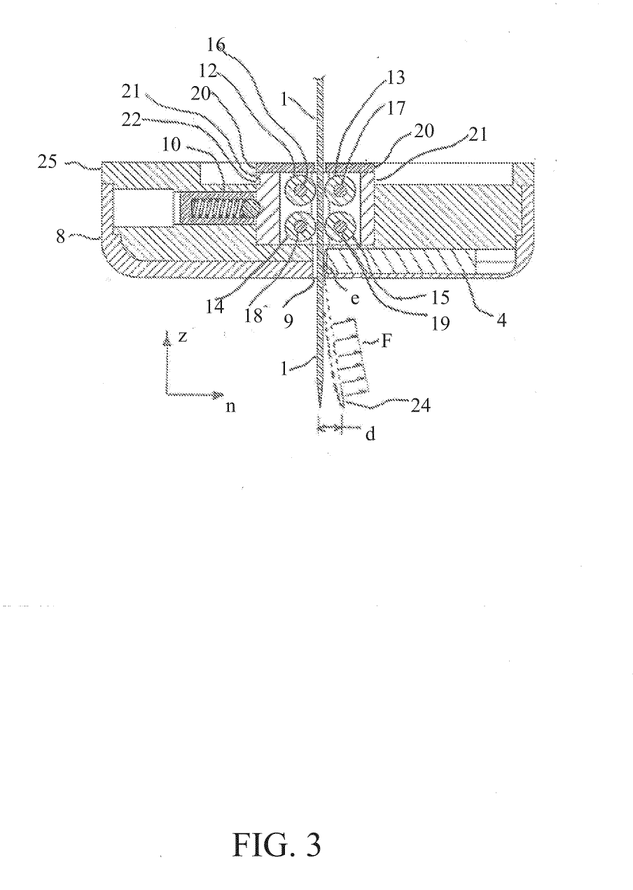

FIG. 1. illustrates an exemplary, non-limiting arrangement of the knife 1 and the proximity sensor 4. The knife 1 includes a plurality of “receding” surfaces 2 and 3 forming a cutting edge 32. To maintain the cutting edge 32, the knife 1 can be periodically sharpened thereby removing material from the receding surfaces 2 and 3 causing the surfaces to recede to the new locations indicated by 5 and 6. The proximity sensor 4 has an axis of sensitivity 7 which is preferably oriented normal to a receding surface 2. The arrangement of knife 1 and proximity sensor 4 preferably includes a small gap (indicated by e) between the receding surface 2 and the proximity sensor 4. As shown in FIG. 3, a side force (indicated by F) on the knife 1 causes it to bend outwardly from its vertical configuration to the configuration indicated by 24. Knife bending causes the small gap e to change, thereby affecting the output of the proximity sensor 4.

In the preferred embodiment of the disclosure, the proximity sensor 4 is a linear inductive sensor and the knife 1 is made from a metal providing a suitable target for the sensor. Inductive sensors produce a signal related to the distance between the sensor and the target. A linear inductive sensor produces a signal that is linearly related to the distance between the sensor and the target. A non-linear inductive sensor will also work for the present embodiments, provided that its signal can be calibrated to relate to the distance between the sensor and the target. Those skilled in the art will recognize equivalent sensors that produce a signal related to a distance to a target, such as capacitive proximity sensors and laser displacement sensors, are envisioned by the present disclosure and fall within the scope hereof.

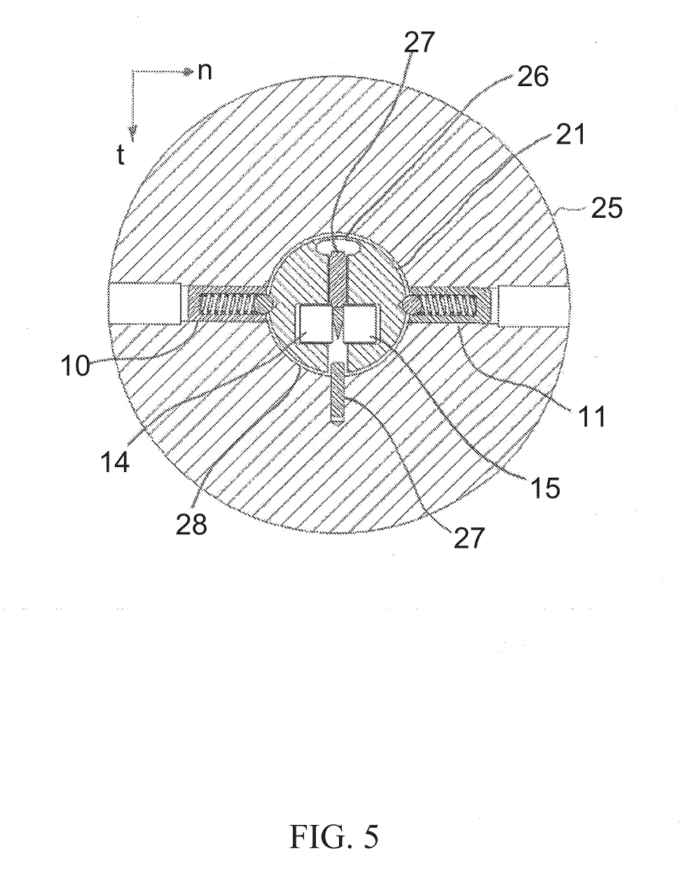

As shown in FIG. 3, as a means for reciprocating the knife 1, a presser foot 8 and a roller guide are used. In FIG. 3, the roller guide includes a plurality of side rollers 12,13,14 and 15 and a rear roller 27 (as shown in FIG. 5), thereby providing support for the knife 1 while allowing it to freely reciprocate in a vertical direction (indicated by coordinate direction z). In the prior art, the roller guide assembly is allowed to displace slightly in a direction normal to the tool path (indicated by coordinate direction n). The prior art roller guide assembly is held by two flexible arms, and bending of the knife is indirectly measured by detecting a corresponding motion of the two flexible arms. As presently embodied, the proximity sensor has been decoupled from the roller guide assembly. This is an advantageous feature since it is desirable to quickly remove the roller guide assembly from the apparatus for cleaning. Since the disclosure avoids the complexities associated with mechanically decoupling the roller guide assembly from either the flexible arms or a sensor, it is possible to quickly remove the roller guide.

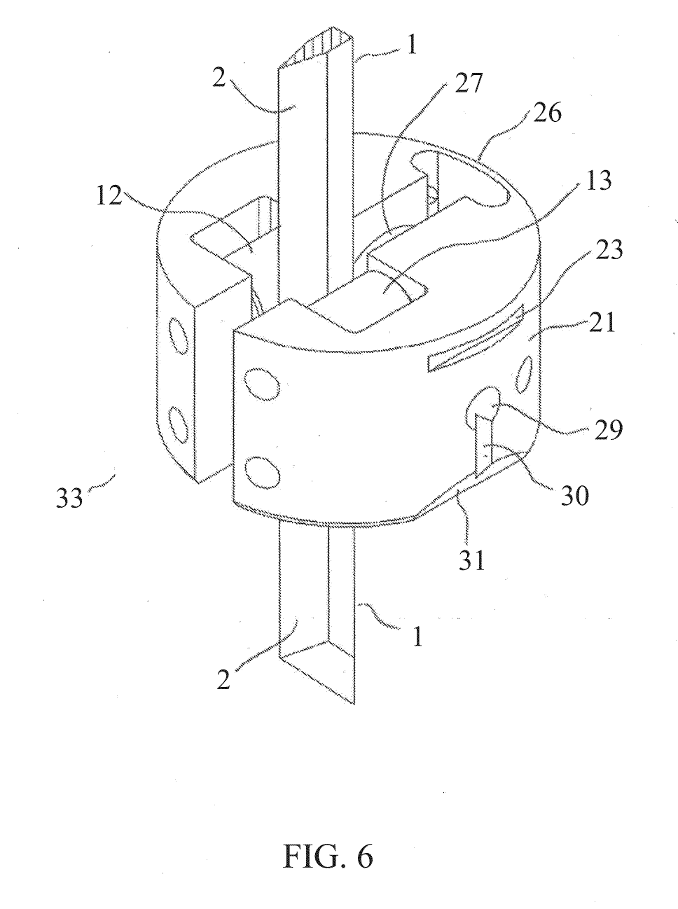

In the preferred embodiment of the present disclosure, as shown in FIG. 6, the roller guide is a quick change roller guide 33 having a frame 21 that resides in a slightly larger pocket 28 of a housing 25 of the presser foot 8 (as shown in FIG. 3). The frame 21 and the pocket 28 are preferably, but not necessarily, cylindrical in shape. As seen in FIG. 5, the frame 21 preferably includes a flexible member 26 allowing limited motion of the plurality of side rollers 12,13,14 and 15 (as shown in FIG. 3) in the normal direction (indicated by n). The motion is limited by the slightly larger pocket 28 and a pin 27. A pair of ball detents 10 and 11 is configured to secure the quick change roller guide 33 in the pocket 28 while applying a controlled force that presses the side rollers 12,13,14 and 15 against the knife 1. Alternatively, the frame 21 may press against the pin 27 allowing for a small amount of clearance between the knife 1 and the side rollers 12,13, 14 and 15.

Heat generated by the reciprocating knife is minimized by allowing for a small clearance while a controlled force provides for better support of the knife 1. Those skilled in the art will recognize the trade-off between the need for minimizing heat generation and the need for better supporting the knife 1. The preferred embodiment of the disclosure may accommodate either need by properly choosing the diameter of the pin 27. As shown in FIG. 6, to facilitate the removal of the quick change roller guide 33, a plurality of grooves 22 and 23 are included to provide grip locations for removal tools. In another embodiment of the disclosure, the quick change roller guide 33 may be secured in the pocket 28 by a pin, screw, magnet or other fastener. As shown in FIG. 3, the preferred embodiment of the present disclosure includes a magnet 20 for collecting debris produced by knife sharpening. The debris may otherwise interfere with the performance of the proximity sensor 4.

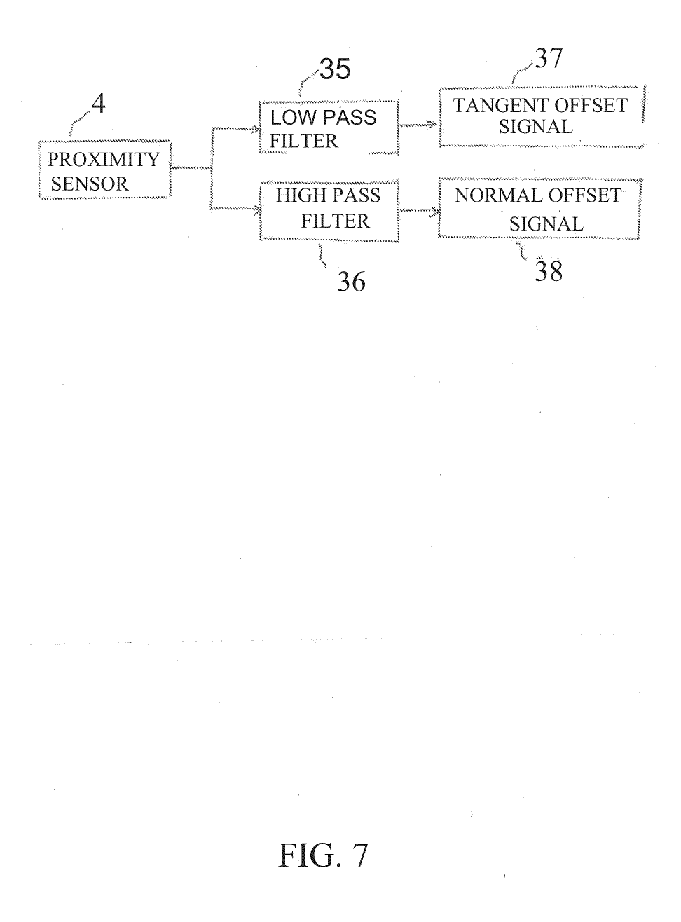

As shown schematically in FIG. 7, the raw output signal of the proximity sensor 4 passes through a low pass filter 35 and a high pass filter 36 to obtain the tangent signal 37 and the normal signal 38, respectively. The low pass filter may include an algorithm executed by a digital computer that calculates a moving average of the raw output signal to obtain the tangent signal 37. The high pass filter may include an algorithm executed by the same digital computer that calculates the difference of the raw output signal and the tangent signal thereby removing the low frequency components from the raw output signal. Those skilled in the art of filter design will recognize alternative means of constructing suitable low pass and high pass filters.

During a normal cutting operation, the raw output signal is expected within a limited range corresponding to the expected range of the gap e between the knife 1 and the proximity sensor 4 (as shown in FIG. 1 and FIG. 3). In the event of a missing or broken knife, the gap e will be larger than normal which produces a raw output signal outside its normal range, which in turn preferably produces a signal indicating a missing or broken knife. These signals may be used by the computer controller of the machine to prevent operating the machine with a missing or broken knife while simultaneously advising the operator of the machine's error condition.

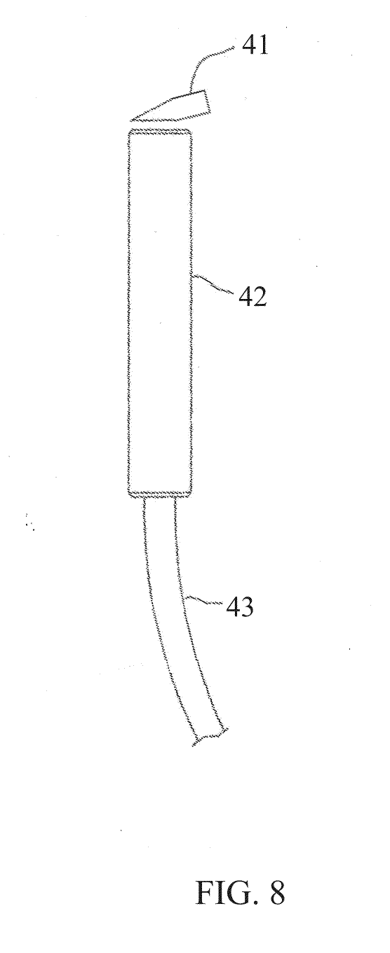

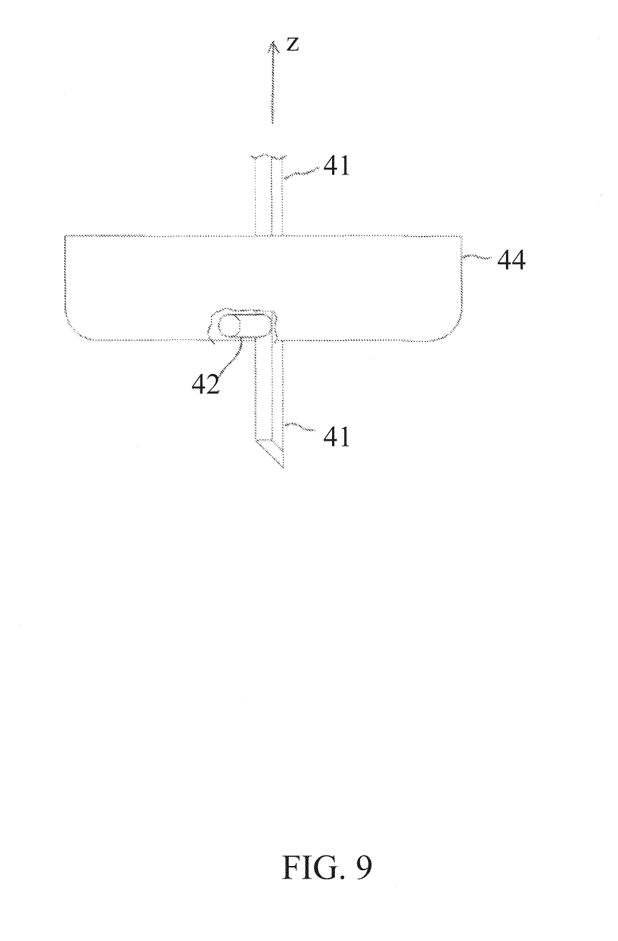

FIGS. 8-9 show an alternate embodiment of the present disclosure. As in the embodiments of the disclosure disclosed above, this embodiment includes the reciprocating knife 41 and the non-contact sensor 42. The reciprocating knife 41 is a well known in the art element of a power tool for cutting shapes of material. In FIG. 8, a cable 43 leading from the non-contact sensor 42 is shown. The non-contact sensor 42 is configured to produce an analog voltage signal related to the temperature. The cable 43 preferably includes two wires carrying the analog voltage signal. As shown in in FIG. 9, a mechanism for reciprocating a knife is provided, having a housing 44 that positions the non-contact temperature sensor 42 relative to the knife 41. The material generally lies flat in a horizontal plane while the knife 41 oscillates in a direction mostly normal to the horizontal plane as indicated by a direction z (as shown in FIG. 9). In another embodiment of the disclosure, the output of the temperature sensor is used as feedback for the automatic closed loop control of reciprocation speed and feedrate. A controller that regulates reciprocation speed and feedrate may include an algorithm that uses a predetermined lookup table that sets the reciprocation speed and feed rate based on the feedback temperature. In yet another embodiment, the housing 44 may additionally function as a presser foot serving to aid in fixturing the material as it is cut.

It is envisioned that elements of any embodiment of the present disclosure can be combined with elements of other embodiments of the present disclosure, all within the scope of the disclosure thereof.

It will be understood to those of ordinary skill in the art that various changes may be made and equivalents may be substituted for elements herein without departing from the scope of the disclosure. In addition, many modifications may be made to adapt a particular feature or material to the teachings of the disclosure without departing from the scope thereof. Therefore, it is intended that the disclosure not be limited to the particular embodiments disclosed, but that the disclosure will include all embodiments falling within the scope of the claims.

What is claimed is:

1. A sensor apparatus for a computer-controlled machine configured to measure tool offsets, comprising:
a knife;
a knife support;
a proximity sensor, having an axis of sensitivity, configured to detect the distance between the knife and a material being cut; and
a housing, configured to support the proximity sensor and the knife support.

2. The sensor apparatus of claim 1, wherein the knife is a reciprocating knife.

3. The sensor apparatus of claim 1, wherein the knife has one or more receding surfaces.

4. The sensor apparatus of claim 1, wherein the axis of sensitivity is oriented mostly normal to at least one of the one or more receding surfaces.

5. The sensor apparatus of claim 1, wherein the sensor is configured to separate the output signal of the proximity sensor into a tangent signal corresponding to a tangent tool offset and a normal signal corresponding to a normal tool offset.

6. The sensor apparatus of claim 1, where the knife support includes:
a roller guide assembly;
a roller guide housing;
a plurality of side rollers; and
at least one rear roller.

7. The sensor apparatus of claim 1, wherein the housing for supporting the proximity sensor and the knife support is a presser foot having a pocket and a fastener for fixturing the roller guide housing.

8. The sensor apparatus of claim 6, wherein the roller guide housing has a flexible member, configured to allow limited motion of the plurality of side rollers in the normal direction.

9. The sensor apparatus of claim 1, wherein the knife includes a non-receding surface mostly parallel to a tangent direction, and mostly normal to the axis of sensitivity.

10. The sensor apparatus of claim 1, wherein the proximity sensor is an inductive sensor.

11. The sensor apparatus of claim 1, further comprising a temperature sensor, configured to measure the temperature of the knife near the point of contact between the knife and a material being cut.

12. The sensor apparatus of claim 11, wherein the temperature sensor is one of a non-contact temperature sensor or a contact temperature sensor.

13. The sensor apparatus of claim 11, further comprising a low pass filter configured to calculate the tangent signal and a high pass filter configured to calculate the normal signal.

14. A sensor apparatus for a computer-controlled machine, comprising:
a knife;
a knife support;
a temperature sensor, configured to measure the temperature of the knife near the point of contact between the knife and a material being cut; and
a housing, configured to support the temperature sensor and the knife support.

15. The sensor apparatus of claim 14, wherein the knife is a reciprocating knife.

16. The sensor apparatus of claim 14, wherein the knife has one or more receding surfaces.

17. The sensor apparatus of claim 14, wherein the axis of sensitivity is oriented mostly normal to at least one of the one or more the receding surfaces.

18. The sensor apparatus of claim 14, where the knife support includes:
a roller guide assembly;
a roller guide housing;
a plurality of side rollers; and
at least one rear roller.

19. The sensor apparatus of claim 18, wherein the roller guide housing has a flexible member, configured to allow limited motion of the plurality of side rollers in the normal direction.

20. The sensor apparatus of claim 14, wherein the temperature sensor is one of a non-contact temperature sensor or a contact temperature sensor.

21. The sensor apparatus of claim 14, wherein the temperature sensor is configured to provide feedback for manual control of the reciprocation speed and federate of the knife.

22. The sensor apparatus of claim 14, wherein the temperature sensor is configured to provide feedback for automatic closed loop control of reciprocation speed and feedrate of the knife.

23. The sensor apparatus of claim 22, further comprising a controller configured to regulate reciprocation speed and feedrate of the knife.

24. The sensor apparatus of claim 23, wherein the controller includes an algorithm and a predetermined lookup table to set the reciprocation speed and feedrate based on the feedback temperature.
